(19) United States
(12) Patent Application Publication
(10) Pub. No.: US 2024/0412377 A1
(43) Pub. Date: Dec. 12, 2024

(54) SYSTEMS AND METHODS FOR ELECTRON CRYOTOMOGRAPHY RECONSTRUCTION

(71) Applicant: SHANGHAITECH UNIVERSITY, Shanghai (CN)

(72) Inventors: Peihao WANG, Shanghai (CN); Jiakai ZHANG, Shanghai (CN); Xinhang LIU, Shanghai (CN); Zhijie LIU, Shanghai (CN); Jingyi YU, Shanghai (CN)

(73) Assignee: SHANGHAITECH UNIVERSITY, Shanghai (CN)

(21) Appl. No.: 18/542,803

(22) Filed: Dec. 18, 2023

Related U.S. Application Data
(63) Continuation of application No. PCT/CN2021/108514, filed on Jul. 26, 2021.

(51) Int. Cl. G06T 7/149; G06T 9/00; G06T 15/10

(52) U.S. Cl. CPC G06T 7/149; G06T 9/002; G06T 15/10; G06T 2207/20081; G06T 2207/20084

(57) ABSTRACT

Described herein are methods and non-transitory computer-readable media of a computing system configured to obtain a plurality of images of an object from a plurality of orientations at a plurality of times. A machine learning model is encoded to represent a continuous density field of the object that maps a spatial coordinate to a density value. The machine learning model comprises a deformation module configured to deform the spatial coordinate in accordance with a timestamp and a trained deformation weight. The machine learning model further comprises a neural radiance module configured to derive the density value in accordance with the deformed spatial coordinate, the timestamp, a direction, and a trained radiance weight. The machine learning model is trained using the plurality of images. A three-dimensional structure of the object is constructed based on the trained machine learning model.

### CROSS REFERENCE TO THE RELATED APPLICATION

This application is the Continuation application of International Application No. PCT/CN2021/108514, filed on Jul. 26, 2021, the entire contents of which are incorporated herein by reference.

### TECHNICAL FIELD

The present invention generally relates to image processing. More particularly, the present invention relates to reconstruction of high-resolution images using a neural radiance field encoded into a machine learning model.

### BACKGROUND

Electron cryotomography (cryo-ET) is a technique in which an electron scanning microscope is used to capture a sequence of two-dimensional images of a sample (e.g., a biological sample, a cell sample, etc.) held at cryogenic temperatures. Under cyro-ET, a sequence of images of a sample can be captured by the electron scanning microscope as the sample is tilted at various different angles under the electron scanning microscope. The tilting of the sample allows the electron scanning microscope to capture images of the sample from different orientations or perspectives. These images can then be combined to generate a three-dimensional rendering of the sample. Under conventional approaches, a simultaneous iterative reconstruction technique (SIRT) in conjunction with a weighted back projection (WBP) can be used to reconstruct a three-dimensional rendering of a sample based on a sequence of captured images of the sample. However, such methods have many drawbacks. For example, because SIRT uses an iterative algorithm to generate a three-dimensional rendering of a sample, it can be time-consuming when the algorithm is executed on various computing systems. Furthermore, in general, high-performance computing systems are needed to execute SIRT. As such, a better methodology of generating three-dimensional rendering of a sample from a sequence of captured images of the sample is needed.

### SUMMARY

Described herein, in various embodiments, are systems, methods, and non-transitory computer-readable media configured to obtain a plurality of images of an object from a plurality of orientations at a plurality of times. A machine learning model can be encoded to represent a continuous density field of the object that maps a spatial coordinate to a density value. The machine learning model can comprise a deformation module configured to deform the spatial coordinate in accordance with a timestamp and a trained deformation weight. The machine learning model can further comprise a neural radiance module configured to derive the density value in accordance with the deformed spatial coordinate, the timestamp, a direction, and a trained radiance weight. The machine learning model can be trained using the plurality of images. A three-dimensional structure of the object can be constructed based on the trained machine learning model.

In some embodiments, each image of the plurality of images can comprise an image identification, and the image identification can be encoded into a high dimension feature using positional encoding.

In some embodiments, the spatial coordinate, the direction, and the timestamp can be encoded into a high dimension feature using positional encoding.

In some embodiments, the plurality of images of the object can be a plurality of cryo-ET images obtained by mechanically tilting the object at different angles.

In some embodiments, the deformation module can comprise a first multi-layer perceptron (MLP).

In some embodiments, the first MLP can comprise an 8-layer MLP with a skip connection at the fourth layer.

In some embodiments, the neural radiance module can comprise a second multi-layer perceptron (MLP).

In some embodiments, the second MLP can comprise an 8-layer multi-layer perceptron (MLP) with a skip connection at the fourth layer.

In some embodiments, the plurality of images can be partitioned into a plurality of bins. A plurality of first sample images can be selected from the plurality of bins. Each of the plurality of first sample images can be selected from a bin of the plurality of bins. The machine learning model can be trained using the plurality of first sample images.

In some embodiments, a piecewise-constant probability distribution function (PDF) for the plurality of images can be produced based on the machine learning model. A plurality of second sample images from the plurality of images can be selected in accordance with the piecewise-constant PDF. The machine learning model can be further trained using the plurality of second sample images.

These and other features of the apparatuses, systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates a diagram of an electron scanning microscope, according to various embodiments of the present disclosure.

FIG. 2A illustrates a scenario in which a plurality of images depicting objects is obtained to train a machine learning model to volumetrically render high-resolution images of the objects, according to various embodiments of the present disclosure.

FIG. 2B illustrates a machine learning model that can volumetrically render high-resolution images of objects, according to various embodiments of the present disclosure.

FIG. 3A illustrates a pipeline depicting a training process to optimize a machine learning model for volumetric rendering of objects, according to various embodiments of the present disclosure.

FIG. 3B illustrates a pipeline depicting a training process to optimize a neural network module for volumetric rendering of objects, according to various embodiments of the present disclosure.

FIG. 4 illustrates a computing component that includes one or more hardware processors and a machine-readable storage media storing a set of machine-readable/machine-executable instructions that, when executed, cause the hardware processor(s) to perform a method, according to various embodiments of the present disclosure.

FIG. 5 is a block diagram that illustrates a computer system upon which any of various embodiments described herein may be implemented.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION OF THE EMBODIMENTS

Described herein is a solution that addresses the problems described above. In various embodiments, the claimed invention can include a machine learning model configured to volumetrically rendering high-resolution images of objects based on a plurality of low-resolution images of the objects. The machine learning model can render high-resolution images of the objects in orientations and/or perspectives that are different from orientations and/or perspectives of the plurality of low-resolution images. The machine learning model can render high-resolution images of the objects based on voxel coordinates of the objects as inputs. In some embodiments, the machine learning model can comprise a space-time deformation module and a neural radiance module. The space-time deformation module can be configured to deform (i.e., convert) voxels of the plurality of low-resolution images from its original space to a canonical space (i.e., a reference space). In this way, the voxels of the plurality of low-resolution images can be based on common coordinates. The neural radiance module can be configured to output intensity values or opacity values of voxels in the canonical space based on deformed voxel coordinates. Based on the intensity values and/or the opacity values, high-resolution images of the objects can be reconstructed. In some embodiments, the space-time deformation module and the neural radiance module can be implemented using an 8-layer multi-layer perceptron. These and other features of the machine learning model are discussed herein.

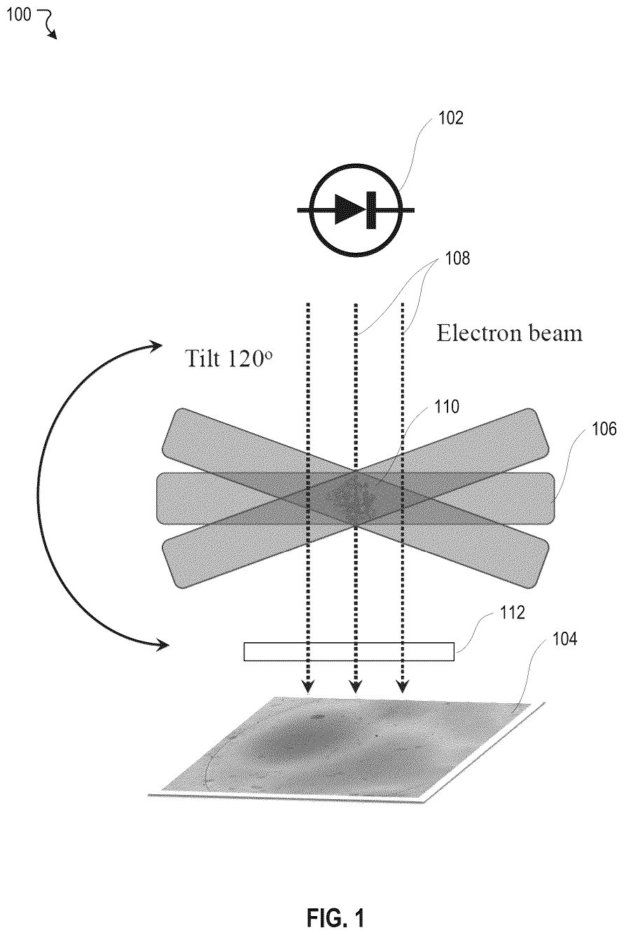

FIG. 1 illustrates a diagram of an electron scanning microscope 100, according to various embodiments of the present disclosure. As shown in FIG. 1, in some embodiments, the electron scanning microscope 100 can include an electron source 102, a detector 104, and a transparent plate 106 disposed between the electron source 102 and the detector 104. The electron source 102 can be configured to generate (e.g., emit) electron beams 108 that can pass through the transparent plate 106 and be received by the detector 104. In general, the transparent plate 106 can be made from any material that is transparent to the electron beams 108. In some embodiments, the transparent plate 106 can include a sample 110 (e.g., a biological sample, a tissue sample, a cell sample, etc.) that is subjected to the electron beams 108. After the electron beams 108 pass through the sample 110, the electron beams 108 can be diffracted. The diffracted electron beams 108 can be refocused by a group of electromagnetic field lens 112 so that the electron beams 108 can be received by the detector 104. The detector 104 can be configured to captures images of the sample 110 as the electron beams 108 are received (i.e., detected). In some embodiments, while the detector 104 is capturing images of the sample 110, the transparent plate 106 can be tilted (e.g., pivoted) along a horizontal axis for +/−60 degrees for a total freedom of tilt of 120 degrees. In this way, various images (i.e., cryo-ET images) can be obtained in a plurality of orientations or perspectives. Further, the images can be obtained by the electron scanning microscope 100 at different times and each image can be timestamped with a time at which the image is captured.

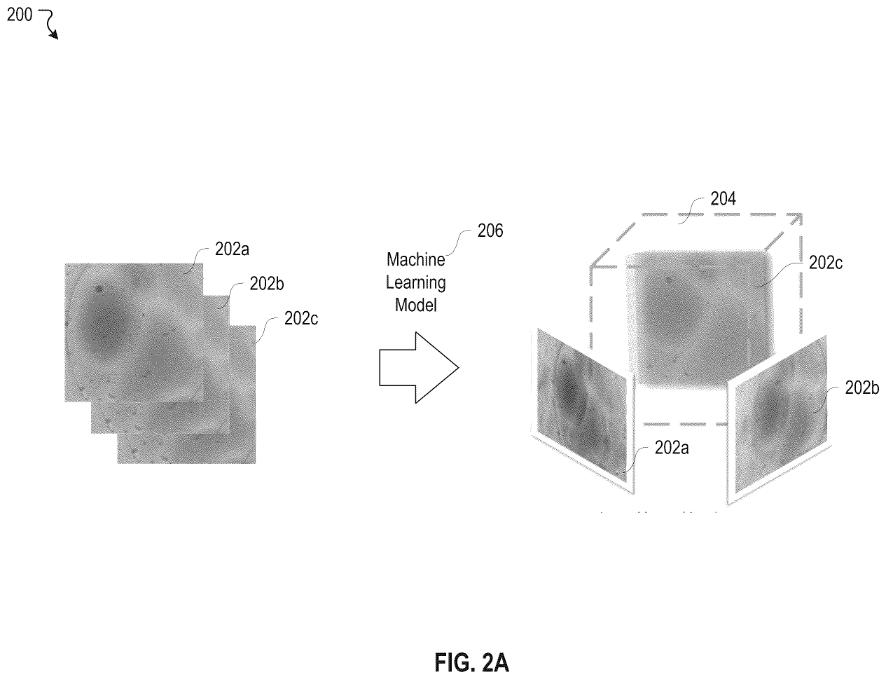

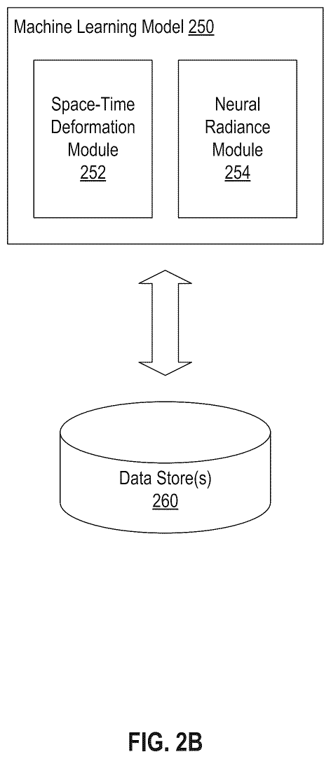

FIG. 2A illustrates a scenario 200 in which a plurality of images 202a-202c depicting objects (e.g., biological samples, cell samples, etc.) is obtained to train a machine learning model to volumetrically render high-resolution images of the objects, according to various embodiments of the present disclosure. As shown in FIG. 2A, in some embodiments, the plurality of images 202a-202c can be obtained from an electron scanning microscope (e.g., the electron scanning microscope 100 of FIG. 1). Each of the plurality of images can represent an image of the objects in different orientations or perspectives. For example, the image 202a can represent an image captured by the electronic scanning microscope when the objects are offset by 0 degrees (i.e., completely horizontal), the image 202b can represent an image captured by the electronic scanning microscope when the objects are offset by +60 degrees, and the image 202c can represent an image captured by the electronic scanning microscope when the objects are offset by −60 degrees. In general, the objects captured by the plurality of images 202a-202c can be deformed in space and time from respective spaces to a canonical space (e.g., a reference space). In this way, various spatial coordinates of voxels (i.e., pixels) corresponding to the objects can be based on a common reference space. In general, in computer vision or computer graphics, voxels are elements of volume (e.g., units of volume) that constitute a three-dimensional space. Each voxel in the three-dimensional space can be denoted by a three-dimensional coordinate system (e.g., Cartesian coordinates). In some embodiments, the objects (e.g., the sample 110 of FIG. 1) depicted in the plurality of images 202a-202c can be represented (e.g., encoded) in a continuous density field of a neural radiance field (NeRF) 204. From the NeRF 204, various high-resolution image of the objects in new orientations or perspectives can be volumetrically rendered. The continuous density field can be represented as a function, v: [symbol] → [symbol] that maps spatial coordinates of voxels in the plurality of images 202a-202c, r=(x, y, z)^{T}, to intensity values and/or opacity values of the voxels and in higher dimensions. In some embodiments, the function presenting the continuous density field can be implemented using a machine learning model 206, ϕ: [symbol] → [symbol] parametrized by weights, or in some cases, normalized weights. For example, in some embodiments, the neural radiance field 204 of the objects depicted the plurality of images 202a-202c can be encoded into a neural network to generate various intensity values of voxels in the NeRF 204. In some embodiments, the machine learning model 206 can comprise a space-time deformation module ϕ^{d} and a neural radiance module ϕ^{r} with each module parameterized by weights, θ^{d} and θ^{r}, respectively. The space-time deformation module ϕ^{d} and the neural radiance module ϕ^{r} will be discussed in further detail with reference to FIG. 2B.

FIG. 2B illustrates a machine learning model 250 that can volumetrically render high-resolution images of objects, according to various embodiments of the present disclosure. In some embodiments, the machine learning model 250 can be implemented as the machine learning model 206 of FIG. 2A. As discussed above, once trained, the machine learning model 250 can be configured to volumetrically render high-resolution images of objects in new orientations and perspectives. As shown in FIG. 2B, in some embodiments, the machine learning model 250 can comprise a space-time deformation module 252 and a neural radiance module 254.

The space-time deformation module 252 can be configured to deform (i.e., convert) voxels of a plurality of images (e.g., the plurality of images 202a-202c of FIG. 2A) from different spaces and time into a canonical space (i.e., a reference space). The space-time deformation module 252 can output corresponding voxel coordinates of the canonical space based on voxel coordinates of the plurality of images. In some embodiments, the space-time deformation module 252 can be based on a multi-layer perceptron (MLP) to handle the plurality of images acquired in various orientations or perspectives. In one implementation, the space-time deformation module 252 can be implemented using an 8-layer multi-layer perceptron (MLP) with a skip connection at the fourth layer. By using an MLP-based deformation network, identifications (i.e., image ID) of the plurality of images can be directly encoded into a higher dimension feature without requiring additional computing and storage overhead as commonly used in conventional techniques. In some embodiments, the space-time deformation module 252 can be represented as follows:

$$Δ r = {ϕ}^{d} ( r , t , {θ}^{d} )$$

where Δr is changes in voxel coordinates from an original space to the canonical space; r is voxel coordinates of the original space; t is an identification of the original space; and θ^{d} is a parameter weight associated with the space-time deformation module 252. Upon determining the changes in the voxel coordinates from the original space to the canonical space, deformed voxel coordinates in the canonical space can be determined as follows:

$${r}^{′} = r + Δ r$$

where r′ is the deformed voxel coordinates in the canonical space; r is the voxel coordinates in the original space; and Δr is the changes in voxel coordinates from the original space to the canonical space. As such, the space-time deformation module 252 can output corresponding voxel coordinates of the canonical space based on inputs of voxel coordinates of the plurality of images.

The neural radiance module 254 can be configured to encode geometry and color of voxels of objects depicted in the plurality of images into a continuous density field. Once the neural radiance module 254 is encoded with the geometry and the color of the voxels (i.e., trained using the plurality of images), the neural radiance module 254 can output intensity values and/or opacity values of any voxel in the NeRF based on a spatial position of the voxel and generate high-resolution images based on the intensity values and the opacity values. In some embodiments, the neural radiance module 254 can be based on a multi-layer perceptron (MLP) to handle the plurality of images acquired in various orientations or perspectives. In one implementation, the neural radiance module 254 can be implemented using an 8-layer multi-layer perceptron (MLP) with a skip connection at the fourth layer. In some embodiments, the neural radiance module 254 can be expressed as follows:

$$σ = {ϕ}^{r} ( {r}^{′} , d , t , {θ}^{r} )$$

where σ is a density value of voxels (e.g., intensity values and/or opacity values); r′ is the deformed voxel coordinates in the canonical space; d is a direction of a ray; t is an identification of the original space; and θ^{r} is a parameter weight associated with the neural radiance module 254. As such, once trained, the neural radiance module 254 can output intensity values and/or opacity values of voxels of the canonical space based on inputs of the deformed voxel coordinates. In this machine learning architecture, both geometry and color information across views and time are fused together in the canonical space in an effective self-supervised manner. In this way, the machine learning model 250 can handle inherent visibility of the objects depicted in the plurality of images and high-resolution images can be reconstructed.

In some embodiments, the machine learning model 250 can be coupled to at least one data store 260. The machine learning model 250 can be configured to communicate and/or operate with the at least one data store 260. The at least one data store 260 can store various types of data associated with the machine learning model 250. For example, the at least one data store 260 can store training data to train the machine learning model 250 for reconstruction of high-resolution images. The training data can include, for example, images, videos, and/or looping videos depicting objects. For instance, the at least one data store 260 can store a plurality of images of biological samples captured by an electron scanning microscope.

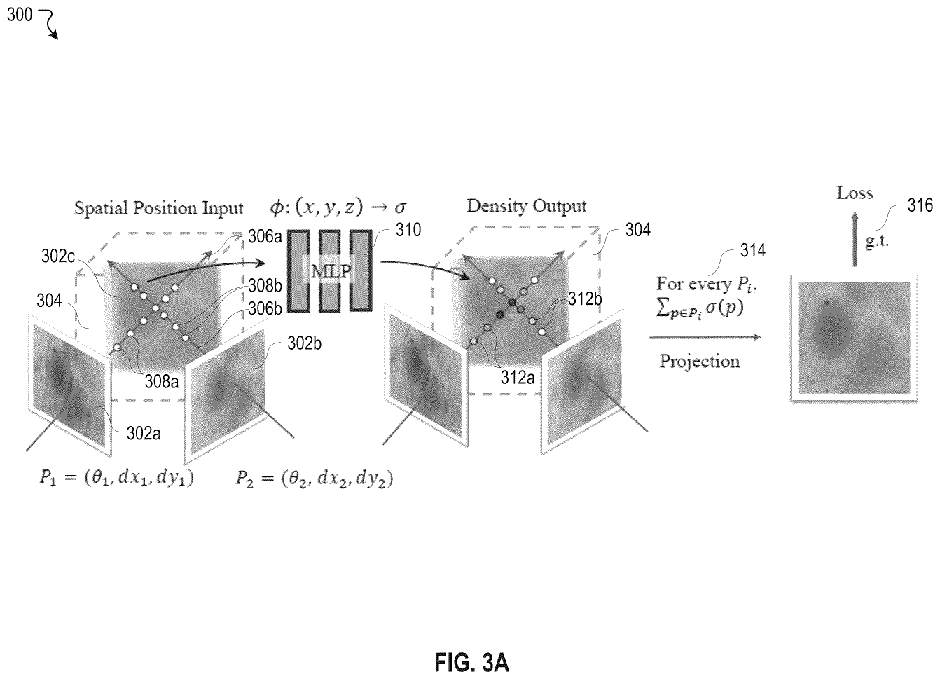

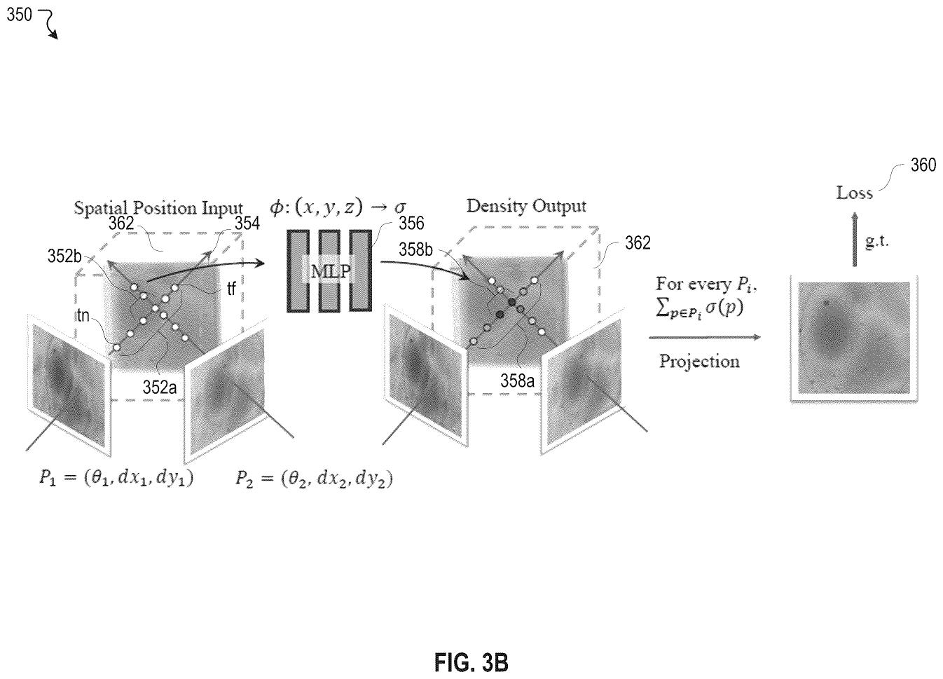

In general, the goal of the machine learning model 250 is to estimate a density volume v of the objects depicted in the plurality of images captured from a plurality of angles, orientations, and/or perspectives for which the density volume is uncertain. In this way, high-resolution images of the object in new angles, orientations, and/or perspectives can be rendered. In some embodiments, the plurality of images can be cyro-ET images captured by an electron scanning microscope (e.g., the electron scanning microscope 100 of FIG. 1). In other embodiments, the plurality of images can be other types of images. For example, in some embodiments, the plurality of images can be magnetic resonance images (MRIs). Many variations are possible. In some embodiments, the plurality of images can be represented as a set of images expressed as:

$$I = \{ {I}_{1} , … , {I}_{N} ∈ {ℝ}^{{D}^{2}} \}$$

where I₁, . . . , I_{N} are images in the set of images I; [symbol] is a dimension of the images; and D is sizes of the images. Each image Iᵢ can contain projections to the object in each image. These projections can be associated with an initial estimated pose Rᵢ∈SO(3) and a timestamp tᵢ∈ [symbol] . These projections can be modulated by a contrast transfer function CTFᵢ before each image is formed (i.e., reconstructed, rendered, etc.). In some embodiments, voxels (e.g., pixels) of each image can be expressed as follows:

$${I}_{i} ( x , y ) = {CTF}_{i} * {\int }_{R} v ( {R}_{i} r + {t}_{i} ) dz$$

wherein character * denotes a convolution operator; r denotes a spatial position of a voxel and can be expressed as r=(x, y, z)^{T}; and tᵢ is a timestamp at which each image is captured. In some embodiments, the contrast transfer function CTFᵢ can be expressed as follows:

$${CTF}_{i} ( x , y ) = {F}^{- 1} [ exp \{ {jX}_{i} ( k ) \} {E}_{s} ( k ) {E}_{t} ( k ) ]$$

where F⁻¹ denotes Fourier transform; the term Xᵢ(k) corresponds to defocus and aberration associated with each image; and the terms Eₛ(k) and Eₜ(k) correspond to spatial and temporal envelope functions, respectively, associated with each image. The terms Eₛ(k) and Eₜ(k) can contain high-order terms of frequencies of beam divergence and energy spread of electron beams with which each image is captured by an electron scanning microscope. In general, the terms Eₛ(k) and Eₜ(k) can be considered as damping terms for the Fourier transform F⁻¹. In some embodiments, the term Xᵢ(k) can be expressed as follows:

$${X}_{i} ( k ) = π ( 0.5 {C}_{s} {λ}^{3} {k}^{4} - Δ {f}_{i} λ {k}^{2} )$$

where Cₛ is a spherical aberration factor; λ is a wavelength of the electron beams (e.g., a wavelength of electron plane waves); and k is a spatial frequency and can be expressed as k=(kₓ, k_{y})^{T}. As such, according to these equations, to recover the density volume v associated with the objects depicted in the plurality of images, for each image, the initial estimated pose Rᵢ of the projections, the timestamp at which each image is captured tᵢ, and the contrast transfer function CTFᵢ needs to be concurrently (i.e., jointly) optimized. The concurrent optimization of the machine learning model 250 is discussed in further detail with reference to FIG. 3A herein.

In general, accuracy of poses associated with the plurality of images can be a significant factor in determining quality of reconstructed images. Hardware-level errors can cause inaccuracies in initial estimates of poses. As such, to address this problem, the traditional neural radiance field (NeRF) architecture can be modified to include, in addition to having tilting angle θᵢ as an input parameter, image-plane offsets dₓ_{ᵢ}, d_{y}_{ᵢ}, which correspond to the initial estimated poses (e.g., Rᵢ and tᵢ), as further input parameters to the machine learning model 250. In this way, a gradient descent process used to optimize the machine learning model 250 can be updated with more accurate initial estimates of poses.

FIG. 3A illustrates a pipeline depicting a training process 300 to optimize a machine learning model for volumetric rendering of objects, according to various embodiments of the present disclosure. In some embodiments, the machine learning model 250 of FIG. 2B can be trained using the training process 300. As shown in FIG. 3A, in some embodiments, training data to train the machine learning model can comprise a plurality of images 302a-302c. Poses associated with the plurality images 302a-302c can be inputted into a space-time deformation module of the machine learning model (e.g., the space-time deformation module 252 of FIG. 2B) (not shown in FIG. 3A) so that voxel (i.e., pixel) coordinates of objects depicted in the plurality of images 302a-302c are converted (e.g., deformed) from its respective spaces to a canonical space. The poses associated with the plurality of images 302a-302c can be represented as Pᵢ=(θᵢ, xᵢ, yᵢ), where θᵢ is a tilting angle of a voxel, and xᵢ and yᵢ are two-dimensional spatial coordinates of the voxel. Based on the poses, the space-time deformation module can output Δxᵢ and Δyᵢ (i.e., Δrᵢ) from which voxel coordinates of the objects in the canonical space can be determined (or derived). For example, as shown in FIG. 3A, based on the space-time deformation module, image offsets dₓ_{ᵢ}, d_{y}_{ᵢ} of the voxel coordinates of the objects in the canonical space can be determined.

Based on the image offsets dₓ_{ᵢ}, d_{y}_{ᵢ} of the voxel coordinates of the objects in the canonical space, a neural radiance module 310 of the machine learning model (e.g., the neural radiance module 254 of FIG. 2B) can be trained to output density values of voxels in the canonical space based on a neural radiance field (NeRF) 304 encoded (e.g., trained) into the neural radiance module 310. To do so, each image of the plurality of images 302a-302c is first ray traced based on updated poses Pᵢ=(θᵢ, dₓ_{ᵢ}, d_{y}_{ᵢ}), where θᵢ is a tilting angle of a voxel in the canonical space, and dₓ_{ᵢ} and d_{y}_{ᵢ} are two-dimensional spatial coordinates of the voxel in the canonical space. For example, as shown in FIG. 3A, a first ray trace 306a can be performed on a pixel of the image 302a based on its pose P₁=(θ₁, dₓ_{₁}, d_{y}_{₁}). As another example, also shown in FIG. 3A, a second ray trace 306b can be performed on a pixel of the image 302b based on its pose P₂=(θ₂, dₓ_{₂}, d_{y}_{₂}). For each of the ray traces 306a, 306b, the neural radiance module 310 can samples voxels 308a, 308b, respectively, along the ray traces 306a, 306b and output predicted intensity values 312a, 312b of the voxels 308a, 308b in the NeRF 304. Predicted intensity values of voxels in the NeRF 304 can be used to train the neural network module 310 of the machine learning model in a self-supervised manner.

In some embodiments, the neural network module 310 of the machine learning model described herein can comprise two stages of training: a coarse stage training and a fine stage training. The training process 300 trains the neural network module 310 such that the two stages of training are simultaneously optimized. For example, FIG. 3B illustrates a pipeline depicting a training process 350 to optimize a neural network module 356 for volumetric rendering of objects, according to various embodiments of the present disclosure. The training process 350 of FIG. 3B is exactly the same as the training process 300 of FIG. 3A. As shown in FIG. 3B, during ray tracing, a first set of voxels 352a at various voxel locations may be sampled along a ray 354 using a stratified sampling technique. These voxel samples can then be used for coarse stage training of the neural network module 356 (e.g., the neural network module 310 of FIG. 3A) to output intensity values 358a corresponding to the first set of voxels 352a. The neural network module 356 can be optimized, for example by using gradient descent, to minimize a loss function 360. The resulting optimized intensity values can be used to determine a probability density function (PDF) to determine a second set of voxels 352b. For example, as shown in FIG. 3B, suppose voxels are sampled along the ray 354 from tₙ to t_{f}. In the stratified sampling technique, voxel points from tₙ to t_{f} are partitioned into evenly-spaced bins. A voxel point is sampled uniformly at random within each of the evenly-spaced bins. This voxel point can be expressed as follows:

$${t}_{i} = U [ {t}_{n} + \frac{i - 1}{{N}_{c}} ( {t}_{f} - {t}_{n} ) , {t}_{n} + \frac{i}{{N}_{c}} ( {t}_{f} - {t}_{n} ) ]$$

where tᵢ is the voxel point sampled uniformly at random; U denotes the evenly-spaced bins; tₙ is the first sampled voxel point along the ray 354; t_{f} is the last sampled voxel point along the ray 354; and N_{c} is a number of evenly-spaced bins. Weights of voxel points randomly selected from each of the evenly-spaced bins can be determined as follows:

$${ω}_{i} = {T}_{i} ( 1 - exp ( 1 {σ}_{i} {δ}_{i} )$$

where ωᵢ is a weight of a voxel point randomly selected from an evenly-spaced bin; σᵢ is an intensity value corresponding to the selected voxel point; and δᵢ an opacity value corresponding to the selected voxel point. The weights of the voxel points can be normalized as follows:

$${\hat{ω}}_{i} = \frac{{ω}_{i}}{{Σ}_{j = 1}^{{N}_{c}} {ω}_{j}}$$

The normalized weights can produce a piecewise-constant probability density function (PDF) along the ray 354. This normalized weight distribution can be used to determine the second set of voxels 352b. In general, the second set of voxels 352b can indicate a region in a NeRF 362 (e.g., the NeRF 304 of FIG. 3A) in which density values 358b change dramatically (indicated by darker circles in FIG. 3B). The first set of voxels 352a and its corresponding intensity values 358a and the second set of voxels 352b and its density values 358b, together, can be used to train the neural network module 356 for fine stage training. In this way, the neural network module 356 can output density values that can increase resolution of reconstructed or rendered images.

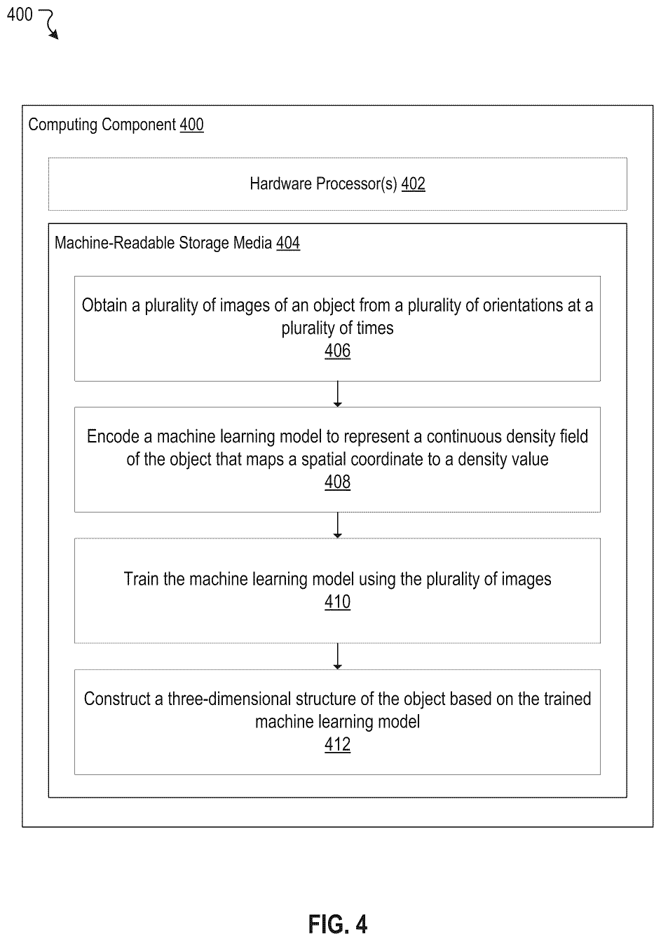

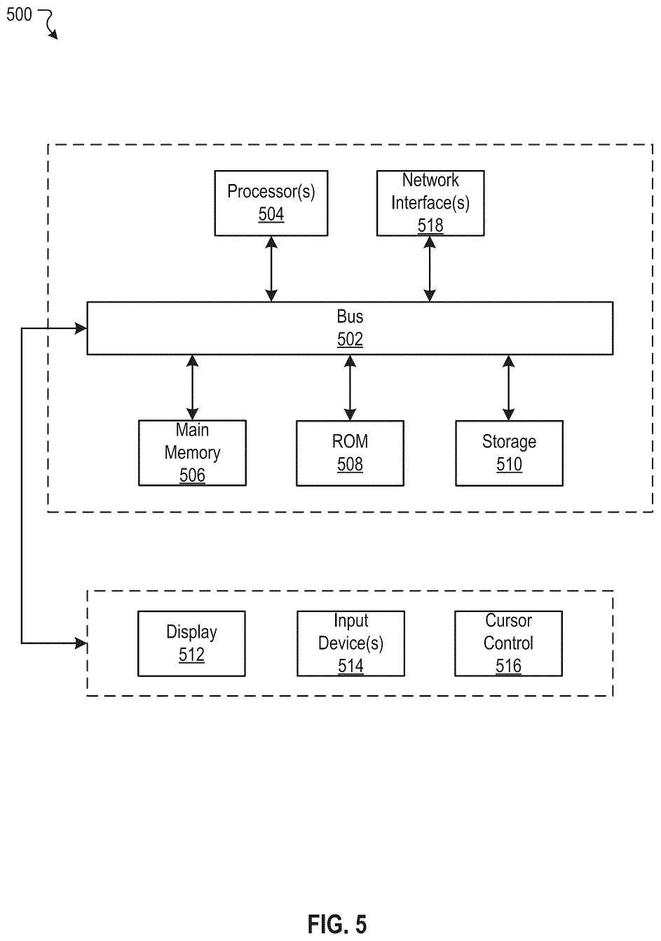

FIG. 4 illustrates a computing component 400 that includes one or more hardware processors 402 and a machine-readable storage media 404 storing a set of machine-readable/machine-executable instructions that, when executed, cause the hardware processor(s) 402 to perform a method, according to various embodiments of the present disclosure. The computing component 400 may be, for example, the computing system 500 of FIG. 5. The hardware processors 402 may include, for example, the processor(s) 504 of FIG. 5 or any other processing unit described herein. The machine-readable storage media 404 may include the main memory 506, the read-only memory (ROM) 508, the storage 510 of FIG. 5, and/or any other suitable machine-readable storage media described herein.

At block 406, the processor 402 can obtain a plurality of images of an object from a plurality of orientations at a plurality of times. In some embodiments, each image of the plurality of images can comprise an image identification, and the image identification can be encoded into a high dimension feature using positional encoding. In some embodiments, the plurality of images can comprise a plurality of cryo-ET images obtained by mechanically tilting the object at different angles.

At block 408, the processor 402 can encode a machine learning model to represent a continuous density field of the object that maps a spatial coordinate to a density value. In some embodiments, the machine learning model can comprise a deformation module configured to deform the spatial coordinate in accordance with a timestamp and a trained deformation weight. In some embodiments, the machine learning model can further comprise a neural radiance module configured to derive the density value in accordance with the deformed spatial coordinate, the timestamp, a direction, and a trained radiance weight. In some embodiments, the spatial coordinate, the direction, and the timestamp can be encoded into a high dimension feature using positional encoding. In some embodiments, the deformation module can comprise a first multi-layer perceptron (MLP). The first MLP can comprise an 8-layer MLP with a skip connection at the fourth layer. In some embodiments, the neural radiance module can comprise a second multi-layer perceptron (MLP). The second MLP can comprise an 8-layer MLP with a skip connection at the fourth layer.

At block 410, the processor 402 can train the machine learning model using the plurality of images. In some embodiments, the plurality of images can be partitioned into a plurality of bins. A plurality of first sample images can be selected from the plurality of bins. Each of the plurality of first sample images can be selected from a bin of the plurality of bins. The machine learning model is trained using the plurality of first sample images. In some embodiments, a piecewise-constant probability distribution function (PDF) for the plurality of images can be produced based on the machine learning model. A plurality of second sample images can be selected from the plurality of images in accordance with the piecewise-constant PDF. The machine learning model can be further trained using the plurality of second sample images.

At block 412, the processor 402 can construct a three-dimensional structure of the object based on the trained machine learning model.

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

FIG. 5 is a block diagram that illustrates a computer system 500 upon which any of various embodiments described herein may be implemented. The computer system 500 includes a bus 502 or other communication mechanism for communicating information, one or more hardware processors 504 coupled with bus 502 for processing information. A description that a device performs a task is intended to mean that one or more of the hardware processor(s) 504 performs.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to output device(s) 512, such as a cathode ray tube (CRT) or LCD display (or touch screen), for displaying information to a computer user. Input device(s) 514, including alphanumeric and other keys, are coupled to bus 502 for communicating information and command selections to processor 504. Another type of user input device is cursor control 516. The computer system 500 also includes a communication interface 518 coupled to bus 502.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features, characteristics, and parameters as the another component.

What we claim is:

1. A computer-implemented method comprising:
obtaining, by a computing system, a plurality of images of an object from a plurality of orientations at a plurality of times;
encoding, by the computing system, a machine learning model to represent a continuous density field of the object, wherein the continuous density field maps a spatial coordinate to a density value, and the machine learning model comprises:
a deformation module configured to deform the spatial coordinate in accordance with a timestamp and a trained deformation weight and to obtain a deformed spatial coordinate; and
a neural radiance module configured to derive the density value in accordance with the deformed spatial coordinate, the timestamp, a direction, and a trained radiance weight;
training, by the computing system, the machine learning model using the plurality of images to obtain a trained machine learning model; and
constructing, by the computing system, a three-dimensional structure of the object based on the trained machine learning model.

2. The computer-implemented method of claim 1, wherein each image of the plurality of images comprises an image identification, and the image identification is encoded into a high dimension feature using positional encoding.

3. The computer-implemented method of claim 1, wherein the spatial coordinate, the direction, and the timestamp are encoded into a high dimension feature using positional encoding.

4. The computer-implemented method of claim 1, wherein obtaining the plurality of images of the object from the plurality of orientations at the plurality of times comprises:
obtaining a plurality of cryo-ET images by mechanically tilting the object at different angles.

5. The computer-implemented method of claim 1, wherein the deformation module comprises a first multi-layer perceptron (MLP).

6. The computer-implemented method of claim 5, wherein the first MLP comprises an 8-layer MLP with a skip connection at a fourth layer.

7. The computer-implemented method of claim 1, wherein the neural radiance module comprises a second multi-layer perceptron (MLP).

8. The computer-implemented method of claim 7, wherein the second MLP comprises an 8-layer multi-layer perceptron (MLP) with a skip connection at a fourth layer.

9. The computer-implemented method of claim 1, wherein training the machine learning model using the plurality of images comprises:
partitioning the plurality of images into a plurality of bins;
selecting a plurality of first sample images from the plurality of bins, wherein each of the plurality of first sample images is selected from a bin of the plurality of bins; and
training the machine learning model using the plurality of first sample images.

10. The computer-implemented method of claim 9, further comprising:
producing, by the computing system, a piecewise-constant probability distribution function (PDF) for the plurality of images based on the machine learning model;
selecting, by the computing system, a plurality of second sample images from the plurality of images in accordance with the piecewise-constant PDF; and
further training, by the computing system, the machine learning model using the plurality of second sample images.

11. A non-transitory computer-readable media of a computing system storing instructions, wherein when the instructions are executed by one or more processors of the computing system, the computing system performs a method comprising:
obtaining a plurality of images of an object from a plurality of orientations at a plurality of times;
encoding a machine learning model represent a continuous density field of the object, wherein the continuous density field maps a spatial coordinate to a density value, and the machine learning model comprises:
a deformation module configured to deform the spatial coordinate in accordance with a timestamp and a trained deformation weight and to obtain a deformed spatial coordinate; and
a neural radiance module configured to derive the density value in accordance with the deformed spatial coordinate, the timestamp, a direction, and a trained radiance weight;
training the machine learning model using the plurality of images to obtain a trained machine learning model; and
constructing a three-dimensional structure of the object based on the trained machine learning model.

12. The non-transitory computing medium of claim 11, wherein each image of the plurality of images comprises an image identification, and the image identification is encoded into a high dimension feature using positional encoding.

13. The non-transitory computing medium of claim 11, wherein the spatial coordinate, the direction, and the timestamp are encoded into a high dimension feature using positional encoding.

14. The non-transitory computing medium of claim 11, wherein obtaining the plurality of images of the object from the plurality of orientations at the plurality of times comprises:
obtaining a plurality of cryo-ET images by mechanically tilting the object at different angles.

15. The non-transitory computing medium of claim 11, wherein the deformation module comprises a first multi-layer perceptron (MLP).

16. The non-transitory computing medium of claim 15, wherein the first MLP comprises an 8-layer MLP with a skip connection at a fourth layer.

17. The non-transitory computing medium of claim 11, wherein neural radiance module comprises a second multi-layer perceptron (MLP).

18. The non-transitory computing medium of claim 17, wherein the second MLP comprises an 8-layer multi-layer perceptron (MLP) with a skip connection at a fourth layer.

19. The non-transitory computing medium of claim 11, wherein training the machine learning model using the plurality of images comprises:
partitioning the plurality of images into a plurality of bins;
selecting a plurality of first sample images from the plurality of bins, wherein each of the plurality of first sample images is selected from a bin of the plurality of bins; and
training the machine learning model using the plurality of first sample images.

20. The non-transitory computing medium of claim 19, wherein the instructions, when executed, further causes the computing system to perform:
producing a piecewise-constant probability distribution function (PDF) for the plurality of images based on the machine learning model;
selecting a plurality of second sample images from the plurality of images in accordance with the piecewise-constant PDF; and
further training the machine learning model using the plurality of second sample images.
